(19) United States
(12) Patent Application Publication
(10) Pub. No.: US 2005/0186529 A1
(43) Pub. Date: Aug. 25, 2005

(54) Assembly of positioning needle and denture mold for positioning denture in plaster cast of the denture mold

(76) Inventor: Chao Hung Lin, Taipei (TW)

Correspondence Address: Chao Hung Lin, 235 Chung-Ho, Box 8-24, Taipei, TW

(21) Appl. No.: 11/054,137

(22) Filed: Feb. 10, 2005

Related U.S. Application Data
(63) Continuation-in-part of application No. 10/782,884, filed on Feb. 23, 2004.

(51) Int. Cl. A61C 19/00

(52) U.S. Cl. 433/74

(57) ABSTRACT

An assembly of a positioning needle and a denture mold for positioning a denture in a plaster cast of the denture mold comprises a plastic cast and a positioning needle. The plaster cast has at least one positioning hole. Two sides of the positioning hole is formed with respective first concave portions for positioning the positioning portion; a second concave portion being extended from the first concave portions. A positioning needle includes a rod for embedding the positioning needle into the plaster cast. Two sides of the rod are extended with a pair of protrusions which are symmetrical. A bottom of each protrusion is extended with a positioning portion. Two lateral surfaces of each positioning portion are installed with positioning contact surfaces. The rod has a positioning surface which is vertically connected to the protrusions. Beside, a top of the rod is connected to an assembling portion.

The present invention is a continuation in part of U.S. patent with Ser. No. 10,782,884, assigned to and invented by the inventor of the present invention, and thus the content of the U.S. patent Ser. No. 10,782,884 is incorporated into the present invention as a part of the specification.

### FIELD OF THE INVENTION

The present invention relates to a assembly of a positioning needle and a denture mold for positioning a denture in a plaster cast of the denture mold, wherein when the denture and the positioning needle are installed to the plaster cast, the denture will not shift or cured, and in the graving process, the denture will not vibrate or displace due to a force applied thereon.

### BACKGROUND OF THE INVENTION

In installing false teeth for filling the gaps between teeth, the dentist must make a denture mold. After the denture mold has been manufactured, whether the denture mold is matched to the gap of the patient is determined by a positioning needle. When a denture is combined to a plaster cast of a denture mold by a positioning needle, the dentist graves on the denture by tools. However, in the graving process, the denture will vibrate or displace so that the denture cannot be easily installed to a tooth supporter of the patient, or the patient will not use the denture successfully.

In one prior art of the positioning needle, when the graver grave a denture on a cast mold, the positioning needle is helpful to reduce the displacement or vibration. However in this prior art, each of two wings from the two sides of a pin has a cambered protrusion at a bottom thereof. Thereby in graving, the displacement or vibration still occurs.

### SUMMARY OF THE INVENTION

Accordingly, the primary object of the present invention is to provide a positioning needle used in a denture mold for positioning a denture in a plaster cast of the denture mold, wherein when the denture and the positioning needle are installed to the plaster cast, the denture will not shift or curled, and in the graving process, the denture will not vibrate or displace due to a force applied thereon.

To achieve above object, the present invention provides an assembly of a positioning needle and a denture mold for positioning a denture in a plaster cast of the denture mold. The assembly comprises a plaster cast having at least one positioning hole; two sides of the positioning hole being formed with respective first concave portions for positioning the positioning portion; a second concave portion being extended from the first concave portions; a positioning needle including a rod for embedding the positioning needle into the plaster cast; two sides of the rod being extended with a pair of protrusions which are symmetrical; a bottom of each protrusion being extended with a positioning portion; two lateral surfaces of each positioning portion being installed with positioning contact surfaces; the rod having a positioning surface which is vertically connected to the protrusions; besides, a top of the rod being connected to an assembling portion. When the denture and the positioning needle are installed to the plaster cast, in the graving process, the denture will not vibrate or displace due to a force applied thereon.

The various objects and advantages of the present invention will be more readily understood from the following detailed description when read in conjunction with the appended drawing.

### BRIEF DESCRIPTION OF THE DRAWINGS

FIG. 1 is a schematic perspective view of the positioning needle of the present invention.

FIG. 2 is a schematic perspective view of FIG. 1 which is viewed from another orientation.

FIG. 3-1 is an exploded schematic view showing the use of the present invention.

FIG. 3-2 is a partial enlarged schematic view of part A of FIG. 3-1.

FIG. 4 is an assembled schematic view of FIG. 3-1.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

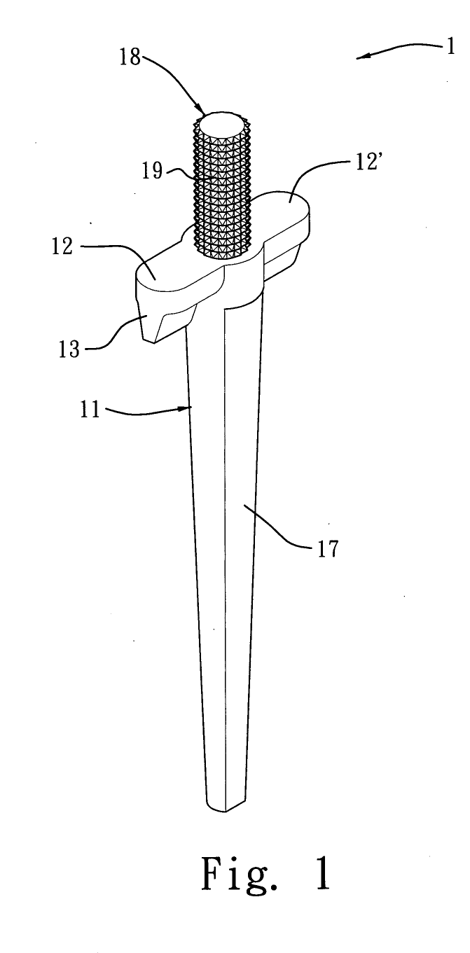

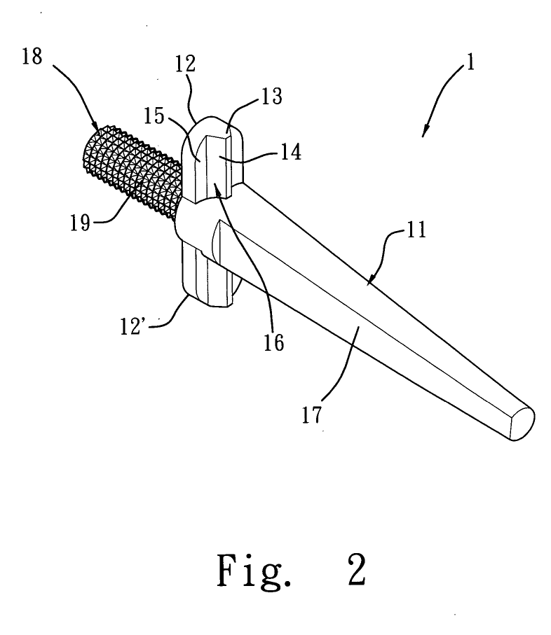

With reference to FIGS. 1 and 2, the positioning needle of the perspective views of the present invention are illustrated. As shown in the drawings, the denture mold of the present invention is the positioning needle used to a denture mold and the structure of a denture mold of the present invention serve to position dentures (not shown) on a plaster cast of a denture mold. Thus, the tooth graver can grave the denture upon the plaster cast of the denture mold. In the graving process, the denture will not vibrate so that no crack generates.

The above mentioned positioning needle 1 has a rod 11 which is embedded into a plaster cast. Two sides of the rod 11 are extended with a pair of protrusions 12, 12′ which are symmetrical. A bottom of each protrusion 12, 12′ is extended with a positioning portion 13 which is reduced downwards. Two lateral surfaces of each positioning portion are installed with positioning contact surfaces 16. By that, the two positioning needle 1 can be steadily positioned on the plaster cast. Furthermore, the rod 11 has a positioning surface 17 which is vertically connected to the protrusions 12, 12′. Thereby, the rod 11 can be embedded into the plaster cast without rotation circumferentially. Besides, a top of the rod 11 is connected to an assembling portion 18. A surface of the assembling portion 18 is installed with a teethed surface 19. After the assembling portion 18 is combined to the denture. The teethed surface 19 serves to prevent the denture from loosing and separation.

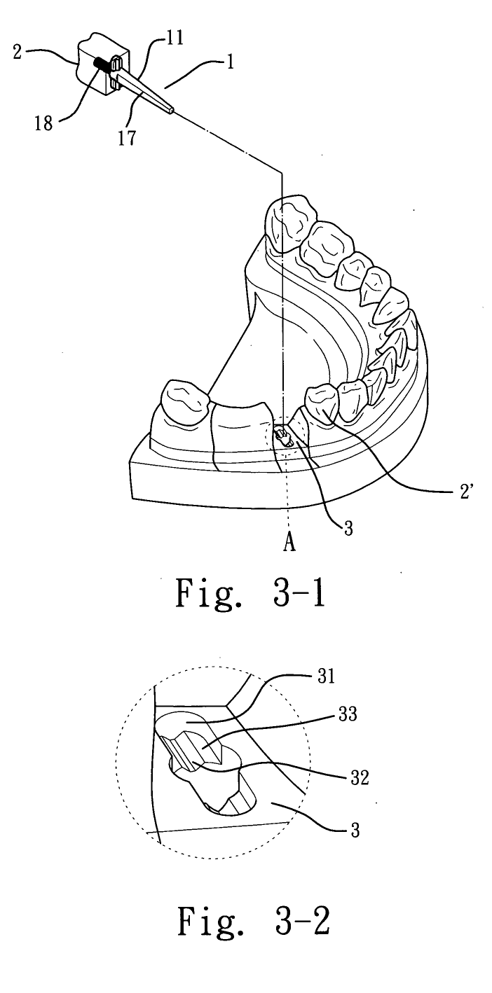

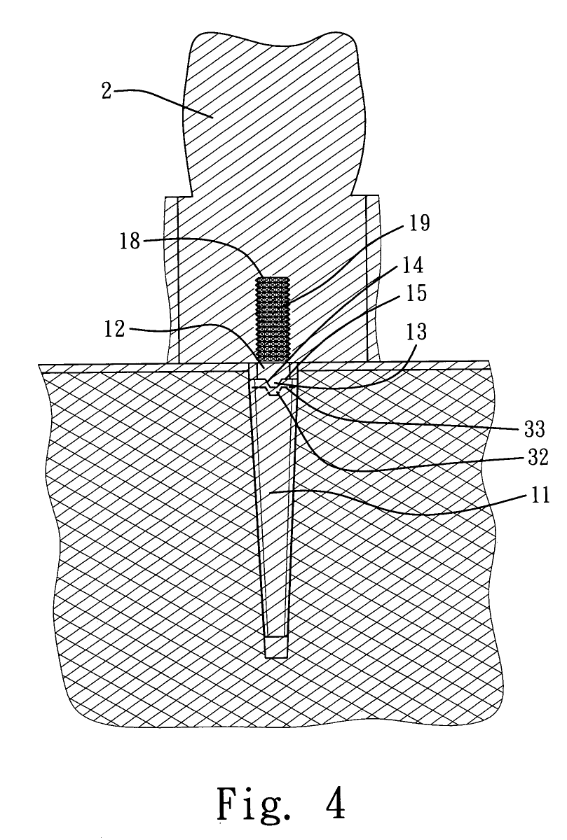

Referring to FIGS. 3-1, 3-2, and 4, the exploded perspective view, the partial enlarge view in part A of 3-1 and an assembled schematic view of the present invention are illustrated. As shown in the drawings, in use of the positioning needle 1, the graver implants the assembly portion 18 of the positioning needle 1 into the denture 2 from the bottom of the denture 2 and the protrusions 12, 12′ at two sides of the positioning needle 1 serves to support the denture. The teethed surface 19 on the surface of the assembling portion 18 will fix the denture 2 effectively so that the denture 2 will not vibrate or rotate on the assembling portion 18.

After assembling the positioning needle 1 and the denture 2, the rod 11 of the positioning needle 1 is embedded into a positioning hole 31 in the plaster cast 3. Two sides of the positioning hole 31 are formed with respective first concave portions 32 for positioning the positioning portion 13. A second concave portion 33 is extended from the first concave portions 32 for positioning the protrusions 12, 12′ and the flanges 101. Thereby, the first and second concave portions 32, 33 will stabilize the positioning contact surface 16 of the positioning needle 1 on the plaster cast 3.

When the denture is combined with the positioning needle 1, and then the positioning needle 1 is embedded into the plaster cast and is pressed therein, the graver will grave the denture 2 by using grinding tools. In the graving process, the force applied by the graver 2 will cause the denture 2 to vibrate or displace, namely, when a force is applied along an X direction, the denture of the plaster cast 3 will not displace along Y direction so that no gap generates between the denture 2 and the denture 2′. Thereby, the position of the denture is matched to the original truth tooth.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A assembly of a positioning needle and a denture mold for positioning a denture in a plaster cast of the denture mold comprising:
a plaster cast having at least one positioning hole; two sides of the positioning hole being formed with respective first concave portions for positioning the positioning portion; a second concave portion being extended from the first concave portions;
a positioning needle including a rod for embedding the positioning needle into the plaster cast; two sides of the rod being extended with a pair of protrusions which are symmetrical; a bottom of each protrusion being extended with a positioning portion; two lateral surfaces of each positioning portion being installed with positioning contact surfaces; the rod having a positioning surface which is vertically connected to the protrusions; besides, a top of the rod being connected to an assembling portion;
wherein when the denture and the positioning needle are installed to the plaster cast, in the graving process, the denture will not vibrate or displace due to a force applied thereon.

2. The positioning needle used in a denture mold for positioning a denture in a plaster cast of the denture mold as claimed in claim 1, wherein the positioning portion is reduced downward.

3. The positioning needle used in a denture mold for positioning a denture in a plaster cast of the denture mold as claimed in claim 1, wherein a surface of the assembling portion has a teethed surface.
